(19) United States
(12) Patent Application Publication
(10) Pub. No.: US 2026/0038485 A1
(43) Pub. Date: Feb. 5, 2026

(54) VOICE-TO-TEXT SPORTS STATISTIC GENERATOR

(71) Applicant: Idaho Show Sports LLC, Boise, ID (US)

(72) Inventor: Katie Anne Newbery, Boise, ID (US)

(21) Appl. No.: 19/291,553

(22) Filed: Aug. 5, 2025

Related U.S. Application Data
(60) Provisional application No. 63/679,459, filed on Aug. 5, 2024.

(51) Int. Cl. G10L 15/16; A63B 71/06

(52) U.S. Cl. CPC G10L 15/16; A63B 71/06

(57) ABSTRACT

Speech data that includes a verbal description of a sporting event is received as an input to a speech-to-statistics (STS) system, which converts the speech data to text and determines a plurality of speech fragments in the text. The speech fragments are provided as inputs to a machine learning model of the STS system, where the machine learning model is a sport-specific model trained based on descriptions of activities in a corresponding particular sport. Based on the speech fragments, statistical data is generated as an output of the machine learning model based on the given speech fragment input, and describe statistics for the particular sport corresponding to the activities described in the verbal description of the sporting event.

### RELATED APPLICATIONS

This application claims benefit to U.S. Provisional Patent Application Ser. No. 63/679,459, filed Aug. 5, 2024, the disclosure of which is incorporated by reference herein in its entirety.

### BACKGROUND

The present disclosure relates in general to the field of speech-to-text (STT) systems, and more specifically, to systems for autonomously adapting speech to structured numerical sports statistics recognition and categorization.

STT systems, also referred to as automatic speech recognition (ASR), have been developed to automatically convert speech information into digital tasks. Such systems have advanced in recent years, leveraging various machine-learning-based models trained on extensive corpora of labeled audio data, enabling real-time or near-real-time transcription with high accuracy across diverse accents, environments, and speaking styles. Techniques such as Connectionist Temporal Classification (CTC), attention-based encoder-decoder models, and transducer-based architectures (e.g., RNN-T) are used to handle the alignment between variable-length audio signals and textual outputs. Recent state-of-the-art implementations incorporate self-supervised pretraining (e.g., wav2vec 2.0, Whisper), multilingual capabilities, and domain adaptation methods to enhance robustness and generalizability. Despite these advancements, challenges remain in adapting speech to particular environments and applications.

### BRIEF DESCRIPTION OF THE DRAWINGS

FIG. 1 is a simplified block diagram of an example autonomous speech-to-statistics (STS) system to interface with an example sports statistics computing platform.

FIG. 2 is a simplified block diagram of components of an example autonomous STS system.

FIG. 3 is a simplified flow diagram showing the example autonomous generation of sports statistic data from speech data entered to an example autonomous STS system.

Like reference numbers and designations in the various drawings indicate like elements.

### DETAILED DESCRIPTION

A speech-to-statistic (STS) integration engine is described, incorporating artificial intelligence (AI)- and/or machine-learning-driven models trained to autonomously generate, in real time, game statistics for a sporting event based on a verbal description of activities in the game. The engine integrates with statistics tracking engines and systems hosting collections of sports statistics (e.g., for analysis and consumption on sporting news websites, etc.), allowing such engines to take advantage of this enhanced data collection technology. By seamlessly integrating with established platforms, this innovation may port with and enhance the functionality of current and future software systems used within the sports industry, enabling users to input game statistics efficiently through spoken commentary (e.g., rather than tedious data entry). The STS engine includes and leverages artificial intelligence to transcribe spoken words into structured data, providing real-time statistical insights during volleyball matches.

Existing sports statistic tracking applications offer valuable features for coaches, players, and analysts. However, manual data entry remains a bottleneck. In some cases, the collection of statistics involves manual collection and entry of statistics by a team of statistics-keepers (or “stat keepers”) either live, during the game play, or from video captured of the event. Often, such in-game stat-keeping is taken using pencil and paper or a separate application and transferring the captured statistics for use with statistics reporting or analytics systems involves an additional, often manual, data entry or data transcription process. Through the tools discussed herein, AI-powered voice-to-text technology is used to allow a single user or audio feed, describing the gameplay, to be processed by the STS system to allow corresponding team- and player-specific statistics to be collected (e.g., in real time, nearly contemporaneous with the capturing of the corresponding audio feed), thereby allowing coaches, players, spectators, recruiters, and media members live access to statistics as they are collected. Such a system may allow improved efficiency and accuracy of sports statistics tracking while maintaining compatibility with familiar interfaces.

In one example, an autonomous sport statistic system may interface with and enhance the capabilities of current sports statistic tracking applications (e.g., for a specific sport (e.g., volleyball, baseball, basketball, etc.) or multiple sports) by adding a voice input functionality. In some implementations, users can activate the STS system within an application on a smart phone, gym announcing system, multimedia broadcasting system, or other device or system equipped with a microphone to provide and capture live commentary using voice commands during games/matches. The integrated AI algorithms of the autonomous STS system accurately transcribe spoken words into text, categorizing them into relevant statistical events (e.g., serves, passes, sets, attacks, blocks, and digs in a volleyball match; hits, at-bats, pitches, balls, strikes, etc. in a baseball or softball game; etc.). The transcribed data seamlessly integrates with existing statistics management platforms, enabling real-time statistic generation and analysis, among other example implementations and benefits.

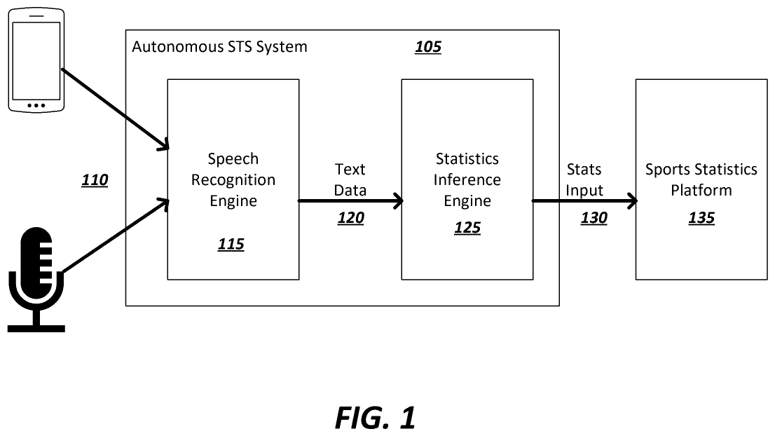

Turning to the FIG. 1, in one example implementation, audio data may be received by an example autonomous STS system 105 and processed by the system to autonomously detect the description of sport-specific statistical events and autonomously map corresponding statistical values to individual players and/or teams participating within the sporting event described in the audio data 110. In some implementations, audio data 110 may be captured in real time by a microphone (e.g., a microphone integrated with or otherwise connected to the computing device (e.g., smartphone, tablet, laptop, scoring system, broadcasting system, etc.) executing the autonomous STS system 105. In other implementations, the audio data 110 may be prerecorded data describing a previously completed sporting event, such as audio data that was captured by a spectator, audio data embodying the audio track of a video or radio broadcast of the event, etc. In some implementations, where multiple different descriptions of the event were captured and embodied in audio data from multiple different sources, these multiple sources may be time synchronized and provided as the input to the autonomous STS system 105 for the determination of statistics for the corresponding sporting event, among other example implementations.

Continuing with the example of FIG. 1, the autonomous STS system 105 may include logic implemented (e.g., hardware or software) to implement a speech recognition engine 115 to convert the audio data into text. The speech recognition engine 115 may utilize custom vocabularies (e.g., sport-specific vocabularies, team- or roster-specific vocabularies, user-specific vocabularies, etc.) and custom or proprietary grammar models to generate text outputs 120 representing the speech included in audio data 110. The custom vocabularies may be submitted to the STS system by a user via a graphical user interface provided by the STS system or may be automatically sourced (e.g., by a web crawler or data capture tool, which may automatically scape other data sources (e.g., a roster of athlete names for teams involved in a current match as served on a server of a sports news or statistics reporting website or service) In some implementations, the grammar utilized by the speech recognition engine 115 is programmatically configured to identify fragments or phrases within the recognized speech that correspond to individual statistical events. For instance, a vocabulary and grammar may be adopted and implemented within the speech recognition engine 115 that is specific to a sport. For instance, an example speech input is presented below for the sake of illustrating various features of an example autonomous STS system 105. Audio data may be collected during a volleyball and interpreted (using logic of the speech recognition engine 115) to read:
The student body has come out in full support of the girls' volleyball team today in their home match against the Valley High Marauders. It's great to see. Here comes the serve, passed by number five. The pass is over the net, Danielle with the pass, a clean set by Anderson, and a hard spike by Norah for the kill!

### Sample 1

In this example, a grammar model may be utilized to identify phrases within the generated text that correspond to statistically meaningful statements. As examples, “Here comes the serve”, “passed by number five on Valley High. The pass is over the net”, “Danielle with the pass”, “a clean set by Anderson”, and “a hard spike by Norah for the kill” may be identified as individual “statistical sentences” appearing with the text, based on the grammar model (e.g., which has been pre-trained against a corpus of statements within the context of the description of example volleyball plays or matches).

Text data 120 generated by the speech recognition engine 115 may be fed to a game statistics inference engine 125. In some implementations, the text data 120 may be structured as statistical sentences fed to the statistics inference engine 125. The statistics inference engine 125 may take as inputs to a machine learning model (e.g., a neural network, random forest classifier, linear regression, decision trees, support vector machine (SVM), k-Nearest Neighbors (kNN), K-Means, ExtRa Trees, Gradient Boosting, among other examples) the text data 120 and team and game models (e.g., defining limits for inferences generated by the statistics inference engine 125) to generate statistics result data 130 that identifies a particular statistic that should attributed to an individual player or team based on the statistical event (e.g., a swing at a baseball pitch, a basketball shot, a tennis serve, a volleyball set, etc.). In one example, the statistical output of the statistics inference engine 125 from a text data input (e.g., a statistical sentence) may be a statistics array which includes, among other example information, a statistical category, a statistical value, and identification of a player/team to attribute the statistic to. In other examples, additional information may be included within the statistics array, such as a timestamp (e.g., corresponding to a period and/or game clock value when the statistical attempt took place, a sequence identifier (e.g., to identify when the statistical event took place relative to an immediately preceding and an immediately subsequent statistical event detected using the statistics inference engine 125), among other examples. These statistical outputs may be output for consumption by a sports statistics platform 135 (e.g., Volley Matrix, Game Changer, MaxPreps, Hudl, etc.), which may format, aggregate, and present statistics for the game or a player in a user-friendly manner; perform additional statistical analysis on the game stats; generate team or game totals from stats collected during the game; present game stats in a live video broadcast or on an in-game scoreboard, among other examples.

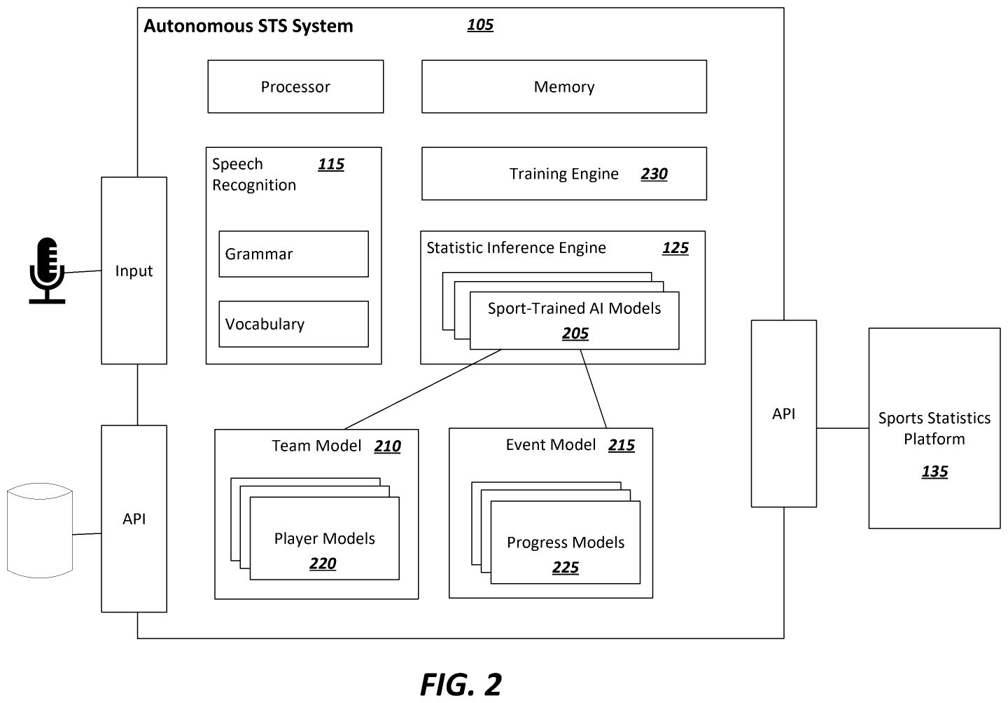

Turning to FIG. 2, a simplified block diagram is presented showing an example implementation of an autonomous STS system 105. The autonomous STS system 105 can include interfaces (e.g., APIs) to receive audio inputs from a peripheral (e.g., microphone) or another system (e.g., storing prerecorded audio of an event). In some implementations, the autonomous STS system 105 may be a sport-specific system for use in generating statistics from speech data for a single sport, while in other implementations, the autonomous sport statistic system 105 may include multiple, trained machine learning models (e.g., used by and/or incorporated in the speech recognition engine 115 and statistics inference engine 125) to selectively support the autonomous generation of sports statistics data from verbal descriptions for any one of multiple different sports (e.g., with some models trained to recognize statistical events of ice hockey, others for baseball, others for basketball, others for volleyball, etc.). In some implementations, the STS system 105 may autonomously identify the sport involved in an instant sporting event being described (e.g., by analyzing content of the spoken commentary, corroborating data captured at the event (e.g., time and date, GPS location, etc.) to infer that the event being described maps to a scheduled event (e.g., by scraping a database of sporting events to identify, for instance, that a given volleyball match involving two specific teams is taking place at a gym corresponding to captured GPS data and at the corresponding date and time), from which the STS system may automatically select the appropriate one of the trained models to apply to the audio data describing the event, among other example features.

The autonomous STS system 105 may include one or more sport-specific, trained machine learning models (e.g., 205) to take, as an input, text data generated by a speech recognition engine 115 from speech data input to the autonomous STS system 105. As noted above, the speech recognition engine 115 may include logic to condition data for input to the statistic inference engine 125, for instance, by identifying segments of the speech that likely correspond to a description of a discrete statistical event within a given sporting event. The statistic inference engine 125 may also utilize data from one or more team models (e.g., 210) corresponding to the teams participating in the sporting event and an event model 215, which models aspects and progress of the particular game or match being described in (and for which statistics are detected from) the speech data. Such information may serve as inputs to provide context features for the inference generated using the statistic inference engine 125 and the sport-specific model used by the statistic inference engine 125 to perform the inference.

Returning to the example of Sample 1 above, text representing a statistical sentence may be provided as an input. While the statistical sentence may be processed according to the trained model 205 to determine that a particular statistical category is implicated by an event described in the statistical sentence, without more context, the system may struggle to identify how to correctly map the statistic to the corresponding player, team, or even assign the correct value(s). For instance, a team model 210 may include constituent player models 220 corresponding to the players on the team. Table and Table 2 representing below illustrate example player models corresponding to a respective first team (the “Rocky Mountain High Miners”) and a respective second team (the “Valley High Marauders”) used in the example of Sample 1:

TABLE 1
Example Player Models
Team Model: Rocky Mountain High Miners

| Jersey No. | Position | First Name | Last Name | Nick Name |
|---|---|---|---|---|
| 25 | Setter | Ava | Anderson | NULL |
| 15 | Outside Hitter | Norah | Perry | No-no |
| 10 | Middle Blocker | Sara | Jackson | NULL |
| 5 | Opposite Hitter | Annaliese | Jones | Lees |
| 21 | Outside Hitter | Danielle | Brunner | Danni |
| 4 | Middle Blocker | Virginia | Benson | Ginny |
| 1 | Libero | Syliva | Rogers | Sylvie |

TABLE 2
Example Player Models
Team Model: Valley High Dragons

| Jersey No. | Position | First Name | Last Name | Nick Name |
|---|---|---|---|---|
| 45 | Opposite Hitter | Abby | Smith | NULL |
| 3 | Middle Blocker | Deidre | Sander | Dee-dee |
| 23 | Outside Hitter | Claire | Jordan | NULL |
| 12 | Setter | Megan | Bryant | NULL |
| 7 | Middle Blocker | Kira | Henry | NULL |
| 4 | Outside Hitter | Evangeline | Perry | Banjo |
| 5 | Libero | Kim | Williams | NULL |

In the example of Table 1 and Table 2, player models may be adapted for rosters of volleyball teams and include, for each of the players, information such as their jersey number, position(s), name, nickname(s), etc. From the team models and constituent player models, the statistics inference engine 125 may correctly map a statistic event to a corresponding player and team. An event model (e.g., 215) modeling the game may also be utilized in the inference. For instance, a statement “Danielle with the pass” may be interpreted to correspond to the instance of a pass by one of the players on the court. The team models may be consulted to complete the inference to understand which player (e.g., “Danielle Brunner” on Rocky Mountain High) should be mapped to the performance of the pass and a corresponding statistic (e.g., tallying a dig for Danielle Brunner). The player models may allow the verbal description to refer to the same player using various terminology, such as the player's first or last name, a nickname, the player's jersey number, etc. In still other examples, the model may be trained to infer the identity of one of the players, even where the description is incorrect or inconsistent in the audio data (e.g., where the speaker misspeaks, noise in the audio data makes the speech difficult to interpret definitively, a new nickname is used, etc.), for instance, by inferring from the sport-specific model that a given described action was most likely performed by a specific player (e.g., a volleyball serve when the server order indicates that a given player was the actual server, a softball swing when the batting order indicates that a given player should be the player attempting the swing, an action that is almost always performed by a player assigned a given position in the match (e.g., a catch at first base by a first baseman, a setting attempt by a setter in volleyball, etc.), among other examples.

As noted above, an event model may be sport-specific and consider the specific rules of the game being played. For instance, the event model may include progress models 225 for various aspects of the game, such as a tracker of which players are in play (and which are on the bench), the assignment of players to given positions (e.g., in a volleyball rotation, in a baseball/softball batting order, etc.), the status of the game's progress (e.g., what is the present/next server in the volleyball rotation, present/next batter in a batting order, which team and its players are currently on offense or defense), etc. As an example, an event model may be utilized by the statistics inference engine to differentiate between two different teams or players. For instance, the statement (from Sample 1) that “passed by number five”, in this example, could correspond to a player wearing jersey number “5” on either the Miners or the Dragons team. However, the event model may track when possession transitions between the teams, among other progress. For instance, the event model may indicate that the serve was from the Miners, allowing the engine 125 to infer that the “number five” is on the Dragons (the team receiving the server) and player “Kim Williams.” Additionally, even a statement with no clear identifier of a particular player, such as “Here comes the serve” cannot only be inferred to refer to a serve event, but the event model may track server order and identify who the present server would be, allowing the serving statistic (e.g., a serve attempt and potentially an ace) to be assigned to the particular player identified using the event model, among other examples (including other sport-specific examples).

In some instances, a single statistical sentence may be used to infer one or multiple statistical categories implicated by the statistical event. In the case where multiple statistical categories are implicated, multiple statistical data results may be generated from a single output. In some cases, multiple text inputs (derived by the speech recognition engine 115) may be input to generate a single statistical data result. As an example, more than one audio description may be present for the sporting event (e.g., multiple recordings by different state keepers (e.g., by stat keepers on each team, or by multiple spectators), a recording by a state keeper combined with the audio of a broadcast of the event, etc.). The multiple recordings may serve as multiple features input to the trained model 205 to infer one or more specific statistical categories to be tallied based on the event described in the recordings. The system may also filter out speech from the input, based on determining that various portions of the speech do not correlate to an event within the sporting event that has significance from the perspective of stat keeping (e.g., the statements (from Sample 1) of “The student body has come out in full support” and “It's great to see,” etc.).

Models may be continuously trained (e.g., using training engine 230 or another model training tool) to improve the performance of the models used by the statistic inference engine 125. A given user or account may provide account-specific information and training data (e.g., roster data, vocabularies, etc.) to adapt the performance of the corresponding instance of the system to a particular user, team, league, etc. Further, a human user may be provided with opportunities (through a user interface of the STS system 105) to double-check or verify the statistics entered (or a second source of statistics capture (e.g., as collected by an Al video statistics tracker)), which may be used as feedback to be provided to the model training system to implement a supervised training loop, among other examples.

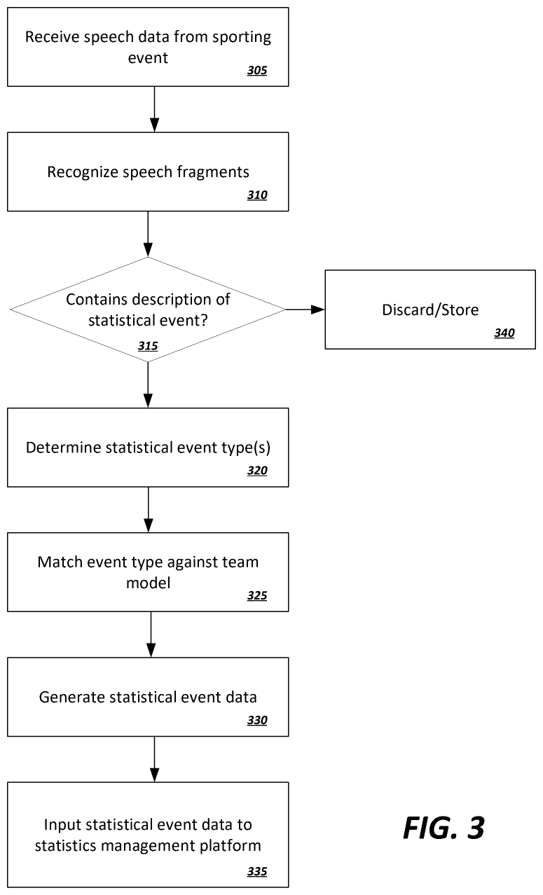

Turning to FIG. 3, a simplified flow diagram is shown of an example technique for autonomously generating statistics for a sporting event from audio data recording a verbal description of the sporting event. The statistics may thereby be generated in real time with the occurrence of the event. Using traditional approaches, comparable stat keeping results would involve a team of potentially multiple stat takers with multiple devices manually entering stats during the event.

In the example of FIG. 3, speech data from a sporting event is received 305 from a source (e.g., microphone, an internet feed, a data store, etc.). Speech recognition logic is utilized to recognize 310 a collection of speech fragments within the speech data. The system can determine 315 (e.g., for each speech fragment) whether the fragment contains a description of a statistical event, or an action or event within the sporting event that would correspond to a statistical category being tallied. If the fragment is determined (e.g., using a trained machine learning model) to not reference a statistic event, the fragment may be discarded 340 (or cached for future or other processing). If the fragment is believed to describe a statistical event, the trained inference engine may be used to determine the statistic event type 320 (and the implicated statistical categories) and the event type may be correlated 325 with a team model to determine a one or more specific players or teams to assign the statistic to. Statistical event data is generated 330 as a result of the inference and identifies the statistical category, a value for the statistic in the sporting event, and the player(s)/team to be associated with the statistic. The statistical event data may be provided 335 to a statistics management platform (e.g., as if manually entered by a user) as part of the overall stat keeping and tracking for the sporting event.

An example autonomous sport statistic system may combine AI-driven voice-to-text technology with a specialized microphone device and a sport-specific language algorithm to offer enhanced sports statistic tracking capabilities. Users can activate the module within the app and provide live commentary using the microphone device, which is designed to capture the commentator's voice while filtering out background noise. The commentator can control the start and stop of the tracking process, allowing for precise data capture during matches or events. The integrated AI algorithms accurately transcribe spoken words into text, categorizing them into relevant game events specific to each sport. Additionally, the module incorporates a sport-specific language algorithm that tailors the transcription process to the unique terminology and language used in each sport, enhancing accuracy and relevance.

Such as introduced above, features of an example autonomous sport statistic system may include:
Voice Input Interface: Users input game statistics through spoken commentary using the microphone device, improving efficiency and usability during matches or events.
AI-Driven Transcription: Advanced AI algorithms accurately transcribe spoken words into structured data, ensuring precision and reliability.
Real-Time Statistic Generation: Transcribed data is processed in real-time, enabling instant statistic generation and analysis.
Start/Stop Control: The commentator can control the start and stop of the tracking process, enabling precise data capture during gameplay.
Sport-Specific Language Algorithm: The module incorporates a sport-specific language algorithm that tailors the transcription process to the unique terminology and language used in each sport, enhancing accuracy and relevance.

Such features may allow the following example advantages:
Control: The commentator can control the start and stop of the tracking process, enabling precise data capture.
Real-Time Visualization: Users can view real-time play movement on the screen while providing commentary, enhancing the tracking experience.
Efficiency: Eliminates the need for manual data entry, saving time and reducing errors across multiple sports.
Relevance: The sport-specific language algorithm ensures that the transcription process is tailored to the unique terminology and language used in each sport, enhancing accuracy and relevance.
Accuracy: AI-driven transcription ensures precise capture and categorization of game events.
Consistency: using traditional methods with multiple different human stat-keepers, different stat-keepers may interpret events differently and apply different statistical standards, automating the process through the described system eliminates such inconsistency
Compatibility: Integrates seamlessly with existing volleyball statistic tracking applications, preserving familiar interfaces.
Accessibility: Intuitive voice interface enhances usability during fast-paced gameplay.
Insights: Provides coaches and analysts with comprehensive statistical insights for strategic decision-making and player development.

Such engines and system can be implemented in various sports contexts, including training sessions, competitive matches, scouting, and player development programs across multiple disciplines such as volleyball, basketball, soccer, football, hockey, and more. By enhancing existing platforms and incorporating a specialized microphone device and sport-specific language algorithm, it offers users a more efficient and accessible method for tracking game statistics, enabling better performance analysis and strategic planning in diverse sports environments.

Note that in this document, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Furthermore, the words “optimize,” “optimization,” and related terms are terms of art that refer to improvements in speed and/or efficiency of a specified outcome and do not purport to indicate that a process for achieving the specified outcome has achieved, or is capable of achieving, an “optimal” or perfectly speedy/perfectly efficient state.

In general, computing systems, which interface with a biosensor via a wired or wireless communication channel, can include electronic computing devices operable to receive, transmit, process, store, or manage data and information associated with the biosensor and other subsystems of the computing system. As used in this document, each of the terms “computer,” “processor,” “processor device,” “microcontroller,” or “processing device” is intended to encompass any suitable data processing apparatus. For example, while the microcontroller may be implemented, in some examples, as a single device within the computing system, in other implementations the processing functionality of the system may be implemented using a plurality of computing devices and processors, such as a fog computing system, server pools, a cloud computing system, or other distributed computing system including multiple computers. Further, any, all, or some of the computing devices may be adapted to execute any operating system, including Linux, UNIX, Microsoft Windows, Apple OS, Apple IOS, Google Android, Windows Server, etc., as well as virtual machines adapted to virtualize execution of a particular operating system, including customized and proprietary operating systems.

In some implementations, all or a portion of a computing platform may function as a wearable device, standalone biosensor device, or other sensor device. A sensor device may connect to and communicate with other computing devices through wired or wireless network connections. For instance, wireless network connections may utilize wireless local area networks (WLAN), such as those standardized under IEEE 802.11 family of standards, home-area networks such as those standardized under the Zigbee Alliance, personal-area networks such as those standardized by the Bluetooth Special Interest Group, cellular data networks, such as those standardized by the Third-Generation Partnership Project (3GPP), and other types of networks, having wireless, or wired, connectivity. For example, an endpoint device may also achieve connectivity to a secure domain through a bus interface, such as a universal serial bus (USB)-type connection, a High-Definition Multimedia Interface (HDMI), or the like.

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

1. A non-transitory machine-readable storage medium with instructions stored thereon, the instructions executable by a machine to cause the machine to:
receive speech data, wherein the speech data comprises a verbal description of a sporting event;
convert the speech data to text;
determine a plurality of speech fragments in the text;
provide a given one of the plurality of speech fragments as an input to a machine learning model, wherein the machine learning model comprises a sport-specific model trained based on descriptions of activities in a corresponding particular sport;
generate statistical data as an output of the machine learning model based on the given speech fragment input.

2. The storage medium of claim 1, wherein the instructions are further executable to pass the statistical data over an interface to a statistic management system.

3. The storage medium of claim 1, wherein the particular sport comprises volleyball.

4. The storage medium of claim 1, wherein the statistical data maps statistics to individual players in a collection of players in the sporting event.

5. The storage medium of claim 4, wherein the instructions are further executable to retrieve roster data from a database, and the roster data identifies the collection of players in the sporting event.

6. The storage medium of claim 1, wherein the machine learning model comprises a first machine learning model, and a different second machine learning model is used to determine the plurality of speech fragments in the text.

7. The storage medium of claim 6, wherein the second machine learning model is also trained specific to the particular sport.

8. The storage medium of claim 1, wherein the speech data is extracted from a video feed of the sporting event.

9. The storage medium of claim 1, wherein the machine learning model is one of a plurality of machine learning models, each of the plurality of machine learning models is trained to be specific to a respective one of a plurality of different sports, and the instructions are further executable to:
identify that the particular sport is played in the sporting event; and
autonomously select the machine learning model from the plurality of machine learning models for use in processing of the speech data.

10. A method comprising:
receiving speech data, wherein the speech data comprises a verbal description of a sporting event;
converting the speech data to text;
determining a plurality of speech fragments in the text;
providing a given one of the plurality of speech fragments as an input to a machine learning model, wherein the machine learning model is trained based on descriptions of a particular sport;
generate statistical data as an output of the machine learning model based on the given speech fragment input.

11. A system comprising:
a processor;
a memory; and
an autonomous sport statistic engine, executable by the processor to:
receive speech data, wherein the speech data comprises a verbal description of a sporting event;
convert the speech data to text;
determine a plurality of speech fragments in the text;
provide a given one of the plurality of speech fragments as an input to a machine learning model, wherein the machine learning model is trained based on descriptions of a particular sport; and
generate statistical data as an output of the machine learning model based on the given speech fragment input.

12. The system of claim 11, wherein the machine learning model comprises a convolutional neural network model.

13. The system of claim 11, wherein the statistical data maps statistics to individual players in a collection of players in the sporting event.

14. The system of claim 13, wherein the autonomous sport statistic engine is further executable to retrieve roster data from a database, and the roster data identifies the collection of players in the sporting event.

15. The system of claim 11, wherein the machine learning model comprises a first machine learning model, and a different second machine learning model is used to determine the plurality of speech fragments in the text.

16. The system of claim 15, wherein the second machine learning model is also trained specific to the particular sport.

17. The system of claim 11, wherein the speech data is extracted from a video feed of the sporting event.

18. The system of claim 11, wherein the machine learning model is one of a plurality of machine learning models, each of the plurality of machine learning models is trained to be specific to a respective one of a plurality of different sports, and the autonomous sport statistic engine is further executable to:
identify that the particular sport is played in the sporting event; and
autonomously select the machine learning model from the plurality of machine learning models for use in processing of the speech data.

19. The system of claim 11, wherein the particular sport comprises one of volleyball, baseball, or softball.

20. The system of claim 11, further comprises a model trainer executable by the processor to train the machine learning model based on labeled statistics data for the particular sport.
